(19) United States
(12) Patent Application Publication
(10) Pub. No.: US 2022/0164498 A1
(43) Pub. Date: May 26, 2022

(54) DEFORMATION PREDICTION METHOD OF MICRO-MILLING THIN-WALLED PARTS

(71) Applicant: DALIAN UNIVERSITY OF TECHNOLOGY, Dalian, Liaoning (CN)

(72) Inventors: Xiaohong LU, Dalian, Liaoning (CN); Yihan LUAN, Dalian, Liaoning (CN); Zhenyuan JIA, Dalian, Liaoning (CN); Feixiang RUAN, Dalian, Liaoning (CN); Han GU, Dalian, Liaoning (CN)

(21) Appl. No.: 17/429,538

(22) PCT Filed: Apr. 19, 2021
(86) PCT No.: PCT/CN2021/087988

§ 371 Date: Aug. 9, 2021

(30) Foreign Application Priority Data
Jun. 16, 2020 (CN) 202010547462.0

(51) Int. Cl. G06F 30/23

(52) U.S. Cl. CPC G06F 30/23; G06F 2111/10

(57) ABSTRACT

The present invention belongs to the precise and efficient processing field of micro parts, in particular to a deformation prediction method of micro-milling thin-walled parts. Firstly, based on the finite element simulation software, a finite element simulation model of micro-milling thin-walled parts is established. Johnson-Cook material model and failure criterion are used to describe the material properties and damage criteria of the machined materials, so as to realize the prediction of milling force in the micro-milling process. The accuracy of the model is verified by experiments. Then, based on the birth-death element method, a deformation prediction model of micro-milling thin-walled parts model is established, and the milling force output from the finite element simulation model is loaded into the deformation prediction model. Finally, the deformation prediction of d micro-milling thin-walled parts is realized.

### TECHNICAL FIELD

The present invention belongs to the precise and efficient processing field of micro parts, in particular to a deformation prediction method of micro-milling thin-walled parts.

### BACKGROUND

With the progress of science and technology, micro products are widely used in aerospace, communication equipment, medical equipment and other fields. Some of the micro parts have the characteristics of mesoscopic thin wall. But high precision machining of micro thin-walled parts is a huge challenge. Micro-milling technology has become an effective method for machining thin-walled parts because of its advantages of high processing efficiency, high precision and low cost. However, thin-walled parts have the characteristics of weak rigidity and poor fabrication procedure, and is easy to deform in micro-milling, which directly affects the machining accuracy of thin-walled parts. Therefore, research on the deformation prediction method of micro-milling thin-walled parts give an important guidance to optimizing the processing conditions of micro-milling thin-walled parts and improving the machining quality.

At present, the research methods of deformation prediction of micro-milling thin-walled parts mainly include experimental method, analytical method and finite element simulation method. More accurate deformation law can be obtained by the experimental method, but the experimental time and economic cost are high. Analytical method takes into account the influence of the tool parameters, the yield strength of the workpiece material and the cutting conditions, but the assumptions and simplifications during the modeling process reduce the prediction accuracy and complicate the modeling process. Finite element simulation method can save cost, and consider the influence of tool and workpiece material comprehensively. The accuracy of deformation prediction is relatively high, but the calculation cost is high. Although there are many research methods for deformation prediction of micro-milling thin-walled parts, its operability, versatility and flexibility need to be further improved. At present, there is still a lack of deformation prediction method with high accuracy, low time and economic cost.

Zhang Weihong et al. put forward a method for predicting the deformation of milling thin-walled parts in the patent THIN-WALLED WORKPIECE MILLING DEFORMATION ERROR PREDICTION METHOD. Considering the workpiece dynamics characteristics of material removal effect, a multi-point tool-workpiece dynamics model was established to solve the relative displacement between the tool and the workpiece. Finally, the circular deformation of milling thin-walled parts with curved surfaces was solved. This method is suitable for the process of traditional milling thin-walled parts with planar and curved surfaces, but the research on deformation prediction of micro-milling thin-walled parts has not been carried out.

Du Zhengchun et al. put forward a rapid realization method and system of deformation of milling thin-walled parts in the patent QUICK REALIZATION METHOD AND SYSTEM FOR MILLING DEFORMATION OF THIN-WALLED PART. The continuous tool path was discretized based on APDL, and the discrete points were selected reasonably. The APDL simulation program, which integrated moving load, birth-death element determination and iterative calculation, could calculate the workpiece deformation caused by milling force quickly and efficiently. However, the deformation of thin-walled parts had not been studied by considering other factors comprehensively.

Although there are many research methods for deformation of micro-milling thin-walled parts due to the complex deformation law of micro-milling thin-walled parts, there is still a lack of deformation prediction method considering many factors comprehensively, with high accuracy of deformation prediction, low time and economic cost.

### SUMMARY

In order to solve the above problems, the present invention provides a deformation prediction method of micro-milling thin-walled parts. Based on the finite element simulation, the accurate prediction of the deformation of micro-milling thin-walled parts is realized, which can provide technical guidance in the process of micro-milling thin-walled parts, improve the machining accuracy and efficiency, and has practical application value.

The technical solution of the present invention is:

A deformation prediction method of micro-milling thin-walled parts. Firstly, based on the finite element simulation software, a finite element simulation model of micro-milling thin-walled parts is established. Johnson-Cook material model and failure criterion are used to describe the material properties and damage criteria of the machined materials, so as to realize the prediction of milling force in the micro-milling process. Then, based on the birth-death element method, a deformation prediction model of micro-milling thin-walled parts model is established, and the milling force output from the finite element simulation model is loaded into the deformation prediction model. Finally, the deformation prediction of d micro-milling thin-walled parts is realized. The specific steps are as follows:

Step 1: Establishment and assembly of tool and workpiece model for finite element simulation model of micro-milling thin-walled parts

The dimensional system should be determined before the establishment of the finite element simulation model of micro-milling thin-walled parts. The input of the finite element simulation software needs to specify the consistent dimensional system, so the simulation model is established based on the SI (mm) unit system.

The structure of a tool model directly affects the precision of micro-milling simulation, and it is difficult to measure the micro geometric size of a micro-milling tool by traditional methods. Images of a tool are taken by an electron microscope. The images are imported into a two-dimensional modeling software to copy the contour of the tool face. The surface profile is used as the benchmark of three-dimensional modeling software to rotate and stretch into three-dimensional tool model. According to the geometrical size of a tool obtained from the images, a three-dimensional geometrical tool model is finally established. A three-dimensional geometrical model of the workpiece (thin-walled part) is established by the finite element simulation software. The three-dimensional geometrical tool model and the three-dimensional geometrical workpiece model constitute the three-dimensional finite element simulation geometric model of micro-milling thin-walled parts.

Finite element simulation is a method to discretize the entity into finite elements for analysis and calculation, so it is necessary to divide the three-dimensional geometric model of the tool and the workpiece into meshes. The quantity and quality of meshes directly affect the accuracy of simulation process. The principle of mesh division is less quantity and better quality. The three-dimensional geometric model of the tool is imported into the finite element simulation software for meshing. Curvature radius is used to mesh the tool to ensure the non-lossy of the tool model. Split functionality is used to refine the meshes at the tool tip and main and secondary cutting edges of the tool model, and the rest of the meshes are divided sparsely, ensuring the quality of key parts of the meshes. The three-dimensional geometric model of the workpiece is divided into machining region and non-machining region. The meshes of machining region are uniform and dense, while the meshes of non-machining region are rough and sparse. Assembly is carried out after the meshing of the tool and the workpiece model is completed

Step 2: Material parameters and failure criteria of the finite element simulation model for micro-milling thin-walled parts

The material removal process of micro-milling is accompanied by large strain and high strain rate, and a large amount of heat will be generated during material slip, deformation and friction. Johnson-Cook material constitutive equation and failure criteria are suitable for describing the strength limit and failure process of metal materials under large strain, high strain rate and high temperature environment. Therefore, Johnson-Cook model is selected to characterize material parameters and failure criteria.

$$σ = ( A + B {ɛ}^{n} ) [ 1 + C ln ( \frac{\dot{ɛ}}{{\dot{ɛ}}_{0}} ) ] ( 1 + {T}^{* m} ) \qquad ( 1 )$$

Where, σ is the stress; A is the yield strength of the material under the reference deformation temperature and the reference strain rate; B is the strain hardening parameter of the material; C is the strain rate coefficient of the material; n is the work hardening parameter of the material; m is the temperature softening parameter of the material; \dot{ε} is the plastic strain rate of the material; \dot{ε}₀ is the reference strain rate of the material; T* is the dimensionless temperature, the expression is Eq. (2).

$${T}^{*} = \frac{T - {T}_{r}}{{T}_{m} - {T}_{r}} \qquad ( 2 )$$

Where, T is the deformation temperature of the material; Tᵣ is the room temperature; Tₘ is the melting temperature of the material.

Johnson-Cook failure criterion is expressed as Eq. (3):

$${ɛ}_{q}^{′} = [ {d}_{1} + {d}_{2} exp ( {d}_{3} \frac{{σ}_{c}}{\overline{σ}} ) ] [ {d}_{4} ln ( \frac{{\dot{ɛ}}_{c}}{{\dot{ɛ}}_{0}} ) + 1 ] [ {d}_{5} {T}^{*} + 1 ] \qquad ( 3 )$$

Where, ε′_{q} is the equivalent failure strain, σ_{c} is the compressive stress; σ̅ is the equivalent stress mean; \dot{ε}_{c} is the equivalent strain rate; \dot{ε}₀ is the reference strain rate; d1-d5 are the failure parameters and are the initial fracture strain influence factor, exponential influence factor, stress influence factor, strain rate influence factor and temperature influence factor, respectively.

Step 3: Interaction and load of finite element simulation model of micro-milling thin-walled parts

In the interaction setting, the contact mode is set as the point-surface contact formed by the geometric surface of the tool and the nodes of the workpiece machining area; The combination of “penalty” contact method and finite sliding are used to describe the interaction between the tool and the workpiece in the machining area. In the “penalty” contact, the normal behavior is set as hard contact to avoid tool penetration, and the tangential behavior is set as frictional contact. The friction coefficient is set according to the material properties of tool and workpiece.

According to the actual processing conditions, the boundary condition of the workpiece is set to fix the bottom surface, and the node set of the bottom surface is established and set as the full constraint, that is, all six degrees of freedom of the workpiece model are fixed. The boundary conditions of the tool are mainly related to the cutting parameters. The three-dimensional geometric model of the tool model is constrained to a reference point, and the spindle speed, cutting depth and feed rate are set at the reference point.

Step 4: Force prediction of the finite element simulation model for micro-milling thin-walled parts

According to Steps 1-3, the finite element simulation model of micro-milling thin-walled parts is completed by setting the boundary condition module of the load of the finite element simulation model of micro-milling thin-walled parts, including spindle speed, feed rate per tooth, axial cutting depth and radial cutting depth. Then the data are checked and the operation is submitted to predict the force of micro-milling thin-walled parts.

Step 5: Geometric models and meshing of the deformation prediction model of micro-milling thin-walled parts

According to the processing requirements, the size of workpiece of the deformation prediction model of micro-milling thin-walled parts is set. The geometrical model of the workpiece is established by using the finite element simulation software. The material properties are consistent with Johnson-Cook model in Step 2, and the meshes of the workpiece are divided. The meshes are divided according to the principle of accurate deformation data output by elements and nodes. Static implicit and three-dimensional stresses are selected for mesh element types to reduce the difficulty of calculation and improve the efficiency of calculation.

Step 6: Element coding and load of the deformation prediction model of micro-milling thin-walled parts

In order to realize the dynamic loading of deformation prediction model of micro-milling thin-walled parts and complete element deletion to simulate the milling process, corresponding analysis steps are needed to be set, and each analysis step contains the element and node at the corresponding position. The processing area is renumbered according to the order of top-to-bottom and left-to-right by the method of element recoding. INP files are used to select the elements and nodes of the deformation prediction model of micro-milling thin-walled parts and set up the SET set. Then, the elements that need to be encoded in the processing area are recoded from 1, and each column of the SET is inputted into the INP file to process and remove part of the elements and their nodes to complete the coding and integration of the elements. The node recoding method is consistent with the element recoding method.

According to Step 4, the finite element simulation model of micro-milling thin-walled parts is used to obtain the micro-milling force value under different cutting parameters. In the deformation prediction model of micro-milling thin-walled parts, the predicted milling forces obtained by the finite element simulation model of micro-milling thin-walled parts are dynamically applied to the SET set to complete the loading process.

Step 7: Element deletion of the deformation prediction model of micro-milling thin-walled parts

The finite element simulation software ABAQUS has the birth-death element technology, which is suitable for simulating the continuous removal process of the chip in the milling process. It belongs to the static implicit analysis, which reduces the calculation cost and improves the calculation efficiency. The birth-death element technology is to multiply the element mass by a value close to zero by mathematical calculation method, that is, to return the element mass to zero, equivalent to “killing” the element, so as to achieve the effect of element removal. In the establishment of the element deletion model of the deformation prediction model of micro-milling thin-walled parts, the micro-milling force loading of each SET is set, and the element is deleted when reaching the failure condition e⁻⁸.

Step 8: Deformation prediction of micro-milling thin-walled parts

According to Steps 5-7, the deformation prediction model of micro-milling thin-walled parts is completed. Dynamic micro-milling force is applied and the node is taken as the output point of the deformation of thin-walled part, which realizing the deformation prediction model of micro-milling thin-walled parts.

Beneficial effects of the present invention: The deformation prediction method of micro-milling thin-walled parts based on cutting process simulation does not need a large number of experiments, and has a strong universality for all kinds of metal materials. The factors such as material properties, material removal and constraint conditions are considered comprehensively. The present method can realize the accurate deformation prediction of micro-milling thin-walled parts, improve the prediction accuracy and efficiency of deformation of micro-milling thin-walled parts, and has practical application value.

### DESCRIPTION OF DRAWINGS

FIG. 1 is a flow chart of the deformation prediction method of micro-milling thin-walled parts of the invention and the corresponding verification process of the invention.

FIG. 2(a) is the comparison between the simulation and the experimental value of the milling force F at the spindle speed of 40,000 rpm.

FIG. 2(b) is the comparison between the simulation and the experimental value of the milling force F at the spindle speed of 50,000 rpm.

FIG. 2(c) is the comparison between the simulation and the experimental value of the milling force F at the spindle speed of 60,000 rpm.

FIG. 3 is a schematic diagram of deformation measurement points in micro-milling thin-walled parts.

FIG. 4(a) is the comparison between the simulation and the experimental value of the deformation at point A at the spindle speed of 40,000 rpm.

FIG. 4(b) is the comparison between the simulation and the experimental value of the deformation at point A at the spindle speed of 50,000 rpm.

FIG. 4(c) is the comparison between the simulation and the experimental value of the deformation at point A at the spindle speed of 60,000 rpm.

FIG. 5(a) is the comparison between the simulation and the experimental value of the deformation at point A at the spindle speed of 40,000 rpm.

FIG. 5(b) is the comparison between the simulation and the experimental value of the deformation at point A at the spindle speed of 50,000 rpm.

FIG. 5(c) is the comparison between the simulation and the experimental value of the deformation at point A at the spindle speed of 60,000 rpm.

FIG. 6(a) is the comparison between the simulation and the experimental value of the deformation at point A at the spindle speed of 40,000 rpm.

FIG. 6(b) is the comparison between the simulation and the experimental value of the deformation at point A at the spindle speed of 50,000 rpm.

FIG. 6(c) is the comparison between the simulation and the experimental value of the deformation at point A at the spindle speed of 60,000 rpm.

### DETAILED DESCRIPTION

Specific embodiment of the present invention is further described below in combination with accompanying drawings and the technical solution.

Deformation is easy to occur and the deformation law is complex in the process of micro-milling of thin-walled parts, which directly affects the machining accuracy of thin-walled parts, the research on deformation prediction technology of micro-milling thin-walled parts provides important reference for optimizing the processing technology of micro-milling thin-walled parts and improving the machining quality. In addition, micro-milling force, material properties and constraint conditions have certain effects on the deformation of micro-milling thin-walled parts. Accordingly, the invention provides a deformation prediction method of micro-milling thin-walled parts aiming at the problem of deformation prediction in micro-milling thin-walled parts.

In the deformation prediction technology of micro-milling thin-walled parts, the dynamic milling force output from the simulation model of micro-milling thin-walled parts is applied one by one to the deformation prediction model, and the material properties, constraints, etc. are comprehensively considered. Through the method of birth-death element to achieve material removal, and obtained the thin-wall micro-milling deformation prediction.

The deformation prediction method of micro-milling thin-walled parts and the corresponding verification process flow of the invention are shown in FIG. 1.

In the finite element simulation model of micro-milling thin-walled parts, the micro-milling tool is a two-edged flat end milling tool with a diameter of 0.6 mm. The selected workpiece material is Inconel 718, and its material parameter performance density is 8,280 kg/m³; elastic modulus is 85,000 MPa; Poisson's ratio is 0.33; specific heat is 435 kg·° C.; thermal expansion coefficient is 0.0000132/° C.; thermal conductivity is 11.4 W/m·° C.

The image obtained by SEM is imported into AutoCAD for accurate description, and the bottom profile is obtained. The 3D geometric model of micro-milling tool is established by importing it into Pro/E software. The finite element software ABAQUS is used to mesh the micro-milling tool model. The meshes at the tool tip and main and auxiliary cutting edges are dense and refined, and the rest of the meshed are sparse and rough. C3D4 mesh is used. The micro-milling tool model is divided into 7342 tetrahedral elements, which are imported into ABAQUS software and set as rigid body. The workpiece model is thin-walled, and its length, thickness and height are 1 mm*0.12 mm*1 mm. It is set as elastic-plastic material. The thin-walled part model can be divided into machining and non-machining area. The mesh division of machining area is uniform and dense, while the mesh division of non-machining area is rough and sparse. The element type of the thin-walled part model is C3D8R, and the number of hexahedral meshes is 335880, Element type is selected as element deletion and hourglass control, which can avoid large deformation and interrupt the simulation process. And in ABAQUS Assembly module, workpiece and micro-milling tool model is transferred and adjusted the relative position to assemble, according to the axial cutting depth of 300 μm and the radial cutting depth of 20 μm. Boundary conditions are defined to strictly constrain the freedom of workpiece bottom surface.

In the Property module of ABAQUS, Johnson-Cook constitutive model parameters of Incone1718 are set. The yield stress A is 985 MPa; the strain hardening parameter B is 985 MPa; the strain rate coefficient C is 0.01; the work hardening parameter n is 0.4; the temperature softening parameter m is 1.61; the reference strain rate \dot{ε}₀ is 0.001/s⁻¹; the melting temperature of the material Tₘ is 1320° C. J-C failure model parameters of Incone1718 are set. The initial fracture strain factor d₁ is 0.04, the exponential factor d₂ is 0.75, the stress factor d₃ is −1.45, the strain rate factor d₄ is 0.04 and the temperature factor d₅ is 0.89. In the Interaction module, the setting of point-surface contact can better reflect the formation of chip and the friction between chip and micro-milling tool, and the calculation efficiency is much higher than that of surface-surface contact. In the contact set of simulation model, the geometric surface of the micro-milling tool and the nodes of the workpiece processing area are set to form a point-surface contact mode.

In the cutting process, friction is the main effect. The interaction between the micro-milling tool and the workpiece in the machining area is described by the combination of “penalty” contact method and finite slip. The normal behavior of contact attribute is hard contact to avoid the penetration of micro-milling tool model. The friction coefficient between carbide micro-milling tool and Incone1718 workpiece is set to be 0.4. The spindle speed of micro-milling tool is set as 40,000 rpm, 50,000 rpm and 60,000 rpm respectively. The feed speed is 1.5 mm/s The axial cutting depth is 0.3 mm. The radial cutting depth is 0.02 mm. In the Job module, the data is created check and the task is submitted for finite element analysis. After the simulation, the milling force is output.

In order to verify the accuracy of thin-walled micro-milling simulation model, the thin-walled micro-milling experiment is designed.

TABLE 1
Comparison of experimental values and
simulative values of milling force

| | Spindle | Experimental | Simulative | Relative |
|---|---|---|---|---|
| Serial | speedₙ | value | value | error |
| number | (rpm) | (N) | (N) | (%) |
| 1 | 40,000 | 0.2974 | 0.3358 | 12.9 |
| 2 | 50,000 | 0.4422 | 0.5055 | 14.3 |
| 3 | 60,000 | 0.6709 | 0.5958 | 16.7 |

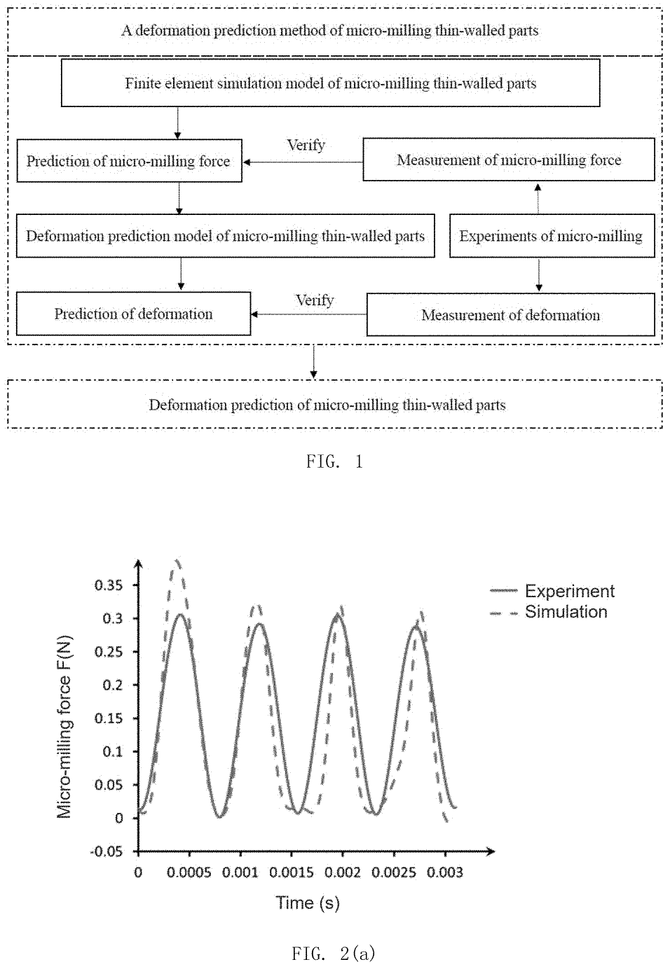

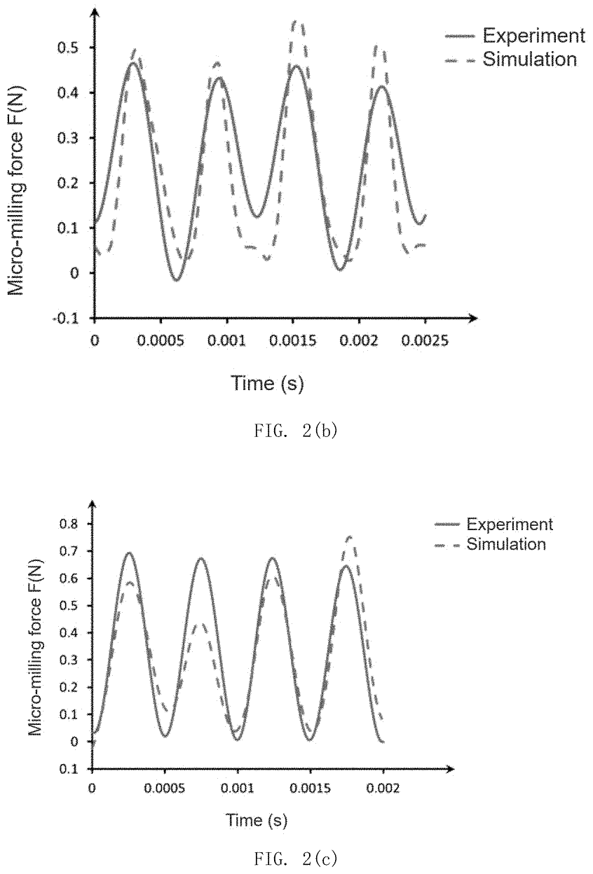

From FIG. 2 (a), (b) and (c), it can be seen that the micro-milling force obtained by simulation is basically consistent with that obtained by experiments, but there is still a deviation. As shown in Table 1, the maximum relative error is 16.7%, and the average relative error is 14.6%. The accuracy of the cutting process simulation model is verified.

The deformation prediction model of micro-milling thin-walled parts mainly includes geometric model, mesh generation, element coding, applied load, element deletion and other modules. The material model and the full constraints of workpiece bottom are consistent with the simulation model of micro-milling thin-walled parts. Meshing: divide the length direction into 100 elements to ensure enough elements and nodes to output deformation data (each element is 50 μm in length, the distance between two nodes is 50 μm). The static implicit and three-dimensional stress are selected as the mesh element type, and the number of meshes is 2100, which greatly reduces the calculation difficulty and improves the calculation efficiency. Element coding: first, change the initial value of the overall number 1 to 5000, and then recode the element to be coded in the processing area from 1. Input the element and its node in each column of the SET set through the INP file to complete the element coding and integration. Load application: the milling force predicted by the simulation model of micro-milling thin-walled parts are successively and dynamically applied to the SET set to complete the loading process. Element deletion: finite element simulation software ABAQUS has birth-death element technology, which is suitable for simulating the continuous chip removal process in the milling process. It belongs to static implicit analysis, which reduces the calculation cost and improves the calculation efficiency. The birth-death element technology is to multiply the element mass by a value close to zero by mathematical calculation method, that is, to return the element mass to zero, equivalent to “kill” the element, so as to achieve the effect of element removal. Using this technique, a certain “kill” limit can be set to realize the discontinuous cutting in the milling process. A set of “death elements” can be set according to the sequence of the milling process. After the “death” of the elements, the analytical step transfer state can be maintained until the end of the milling process. In the establishment of the element deletion model, the milling force loading of each SET set is set, and the element is deleted after reaching the failure condition e⁻⁸.

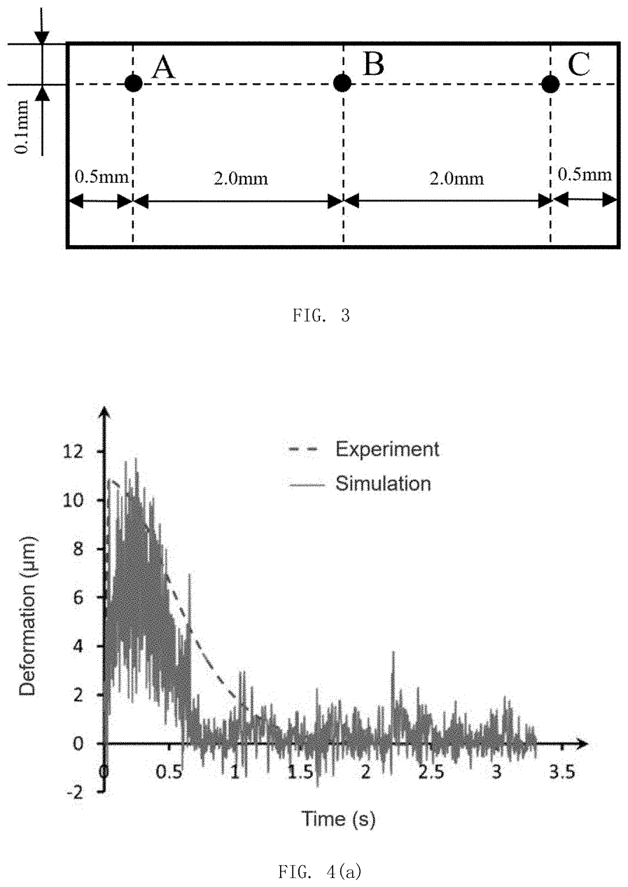

To verify the accuracy of the deformation prediction model of micro-milling thin-walled parts, experiments of micro-milling thin-walled parts are designed. LTC-025-02 laser displacement sensor is used to measure the deformation of thin-walled parts in real time. The experimental measurement points are at A, B and C of the non-machined side of the thin-walled part, as shown in FIG. 3. The deformation of the same position is compared and verified.

TABLE 2
Comparison of experimental values and
simulative values of deformation

| | Spindle | Measurement | Experimental | Simulative | Relative |
|---|---|---|---|---|---|
| Serial | speedₙ | point | value | value | error |
| number | (rpm) | location | (μm) | (μm) | (%) |
| 1 | 40,000 | A | 11.652 | 10.956 | 5.97 |
| 2 | 40,000 | B | 6.847 | 7.396 | 8.02 |
| 3 | 40,000 | C | 18.435 | 16.830 | 8.71 |
| 4 | 50,000 | A | 9.576 | 9.919 | 3.58 |
| 5 | 50,000 | B | 8.636 | 7.398 | 14.34 |
| 6 | 50,000 | C | 12.556 | 11.987 | 4.53 |
| 7 | 60,000 | A | 7.733 | 7.242 | 6.35 |
| 8 | 60,000 | B | 6.543 | 6.044 | 7.63 |
| 9 | 60,000 | C | 9.427 | 8.455 | 10.31 |

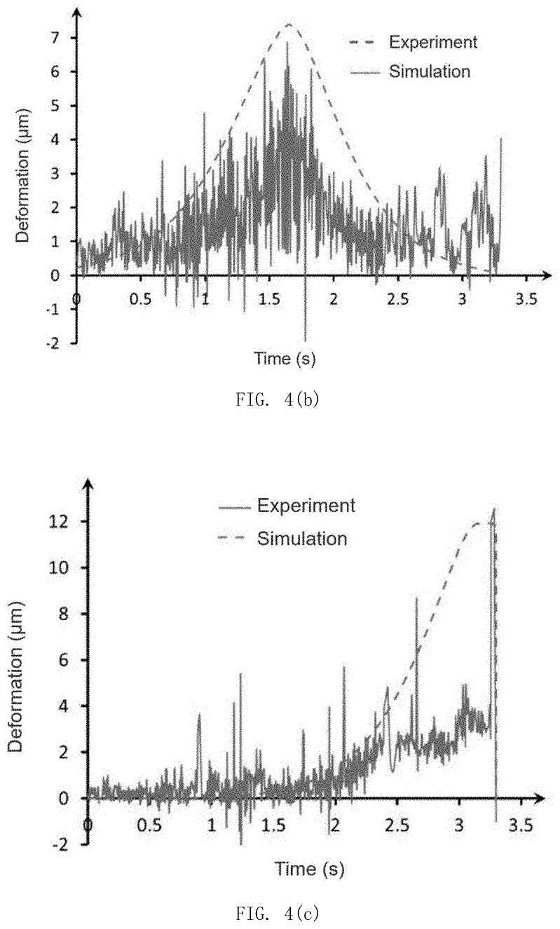

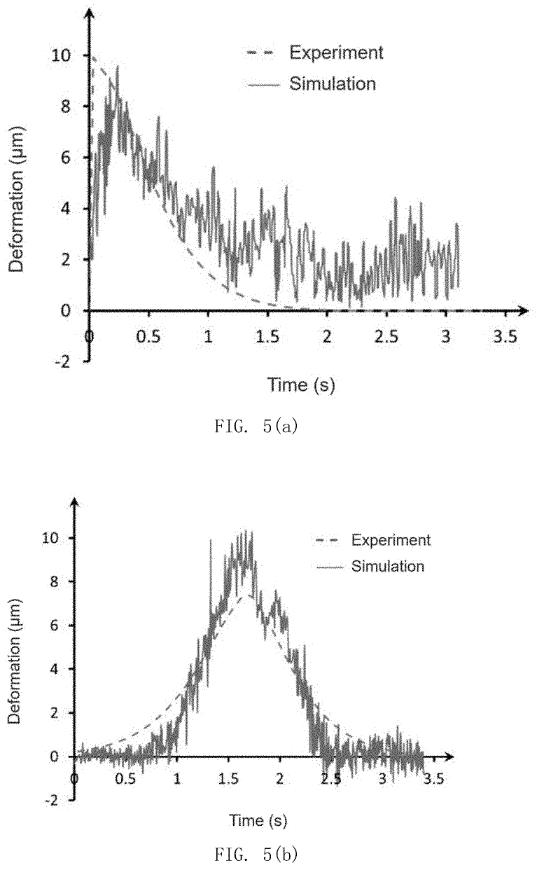

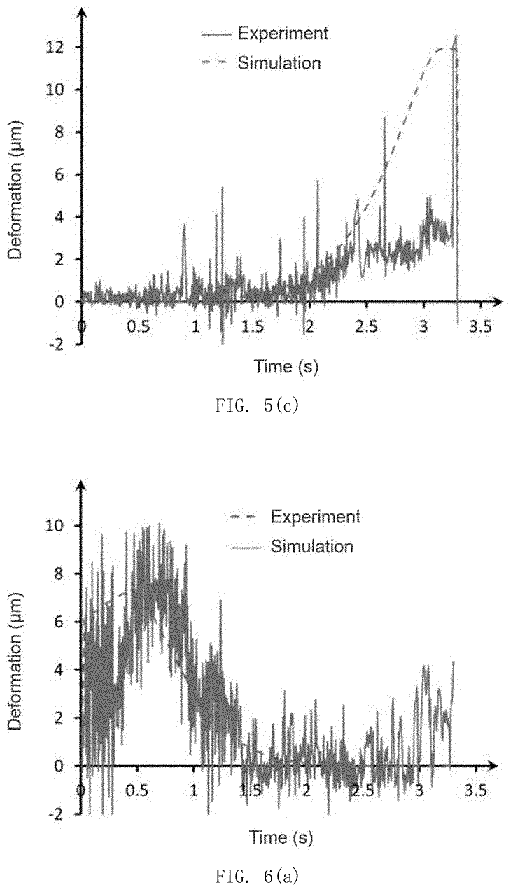

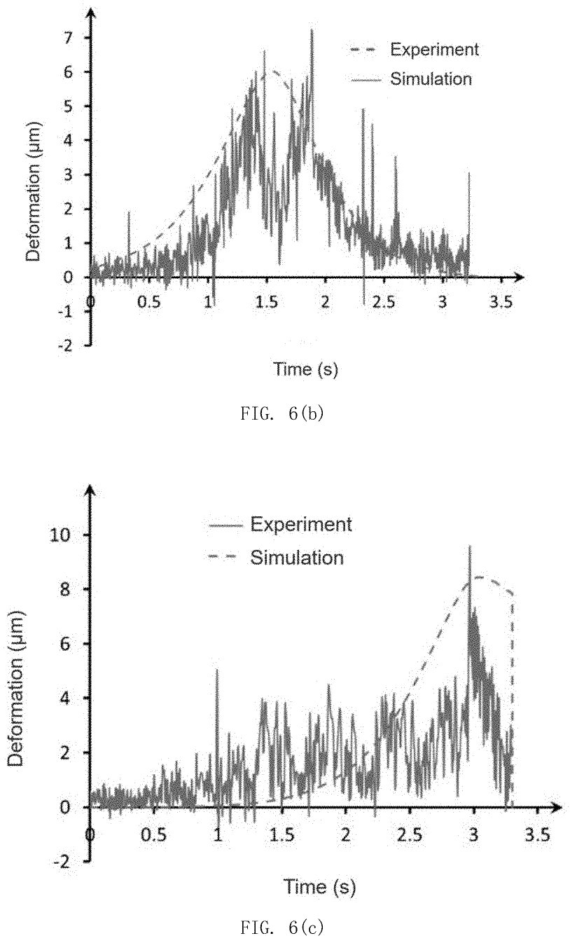

From FIGS. 4(a), 4(b), 4(c), 5(a), 5(b), 5(c), 6(a), 6(b) and 6(c), it can be seen that the overall variation trend of experimental measured deformation is consistent with that of simulative value. Table 2 shows that the order of the maximum deformation at points A, B and C is C>A>B. Since the two ends of the thin-walled part (A and C) are unilateral constraints and the rigidity is weaker than that of the middle position (B), the deformation at both ends is greater than that of the middle position. As the cutting process goes on, the thin-walled part material is removed continuously, and the overall stiffness of the thin-walled part material decreases gradually, resulting in A larger deformation at the end point (C) than at the starting point (A). The maximum relative error of deformation prediction of micro-milling thin-walled parts is 14.34%, and the average relative error is 7.72%. The accuracy of the deformation prediction model of micro-milling thin-walled parts is proved.

The accuracy of the deformation prediction of micro-milling thin-walled parts based on the method proposed by the present invention is verified.

1. A method for deformation prediction of micro-milling thin-walled parts, comprising steps of:
step 1: establishment and assembly of tool and workpiece model for finite element simulation model of micro-milling thin-walled parts
establishing a finite element simulation model of micro-milling thin-walled parts based on SI unit system;
taking image of the tool by electron microscope, and importing the image into a two-dimensional modeling software to copy front contour of the tool; using the front contour as benchmark of a three-dimensional modeling software to rotate and stretch into the three-dimensional tool; carrying out cutting and optimization according to geometric dimensions of the tool obtained from side images, and obtaining a three-dimensional geometric model of the tool; establishing a three-dimensional geometrical model of the workpiece by the finite element simulation software, the workpiece is thin-walled part; the three-dimensional geometrical tool model and the three-dimensional geometrical workpiece model constitute the three-dimensional finite element simulation geometric model of micro-milling thin-walled parts;the three-dimensional geometric model of tool and workpiece needs to be meshed after being established; importing the three-dimensional geometric model of tool into a finite element simulation software for meshing; using curvature radius to mesh the tool model to ensure the non-lossy of the tool model; using split functionality to refine the meshes at the tool tip and main and secondary cutting edges of the tool model, and dividing the rest of the meshes sparsely, ensuring the quality of key parts of the meshes; dividing three-dimensional geometric model of the workpiece into machining and non-machining region; the meshes of machining region are uniform and dense, while the meshes of non-machining region are rough and sparse; carrying out assembly after the meshing of the tool model and the workpiece model is completed;
step 2: material parameters and failure criteria of the finite element simulation model for micro-milling thin-walled parts
using Johnson-Cook model to characterize the material parameters and failure criteria;
Johnson-Cook constitutive model is expressed as Eq. (1):
$$σ = ( A + B {ɛ}^{n} ) [ 1 + C ln ( \frac{\dot{ɛ}}{{\dot{ɛ}}_{0}} ) ] ( 1 - {T}^{* m} ) \qquad ( 1 )$$
where, σ is stress; A is yield stress; B is strain hardening parameter; C is strain rate coefficient; n is work hardening parameter; m is temperature softening parameter; \dot{ε} is plastic strain rate; \dot{ε}₀ is reference strain rate; T* is dimensionless temperature, the expression is Eq. (2)
$${T}^{*} = \frac{T - {T}_{r}}{{T}_{m} - {T}_{r}} \qquad ( 2 )$$
where, T is deformation temperature; Tᵣ is room temperature; Tₘ is melting temperature;
Johnson-Cook failure criterion is expressed as Eq. (3):
$${ɛ}_{q}^{′} = [ {d}_{1} + {d}_{2} exp ( {d}_{3} \frac{{σ}_{c}}{\overline{σ}} ) ] [ {d}_{4} ln ( \frac{{\dot{ɛ}}_{c}}{{\dot{ɛ}}_{0}} ) + 1 ] [ {d}_{5} {T}^{*} + 1 ] \qquad ( 3 )$$
where, ε′_{q} is equivalent failure strain, σ_{c} is compressive stress; σ̅ is equivalent stress mean; \dot{ε}_{c} is equivalent strain rate; \dot{ε}₀ is reference strain rate; d₁-d₅ are failure parameters and are initial fracture strain influence factor, exponential influence factor, stress influence factor, strain rate influence factor and temperature influence factor, respectively;
step 3: interaction and load of finite element simulation model of micro-milling thin-walled parts
in the interaction setting, setting contact mode as point-surface contact formed by the geometric surface of the tool and the nodes of the workpiece machining area; using the combination of “penalty” contact method and finite sliding to describe the interaction between tool and workpiece in the machining area; in the “penalty” contact, setting normal behavior as hard contact, and setting tangential behavior as frictional contact; setting friction coefficient according to the material properties of tool and workpiece;
according to the actual processing conditions, setting boundary condition of the workpiece to fix the bottom surface, and establishing node set of the bottom surface and setting as full constraint, that is, all six degrees of freedom of the workpiece model are fixed; constraining the three-dimensional geometric model of the tool model to a reference point, and setting rotating speed, cutting depth and feed rate at the reference point;
step 4: force prediction of the finite element simulation model for micro-milling thin-walled parts
according to steps 1-3, completing the finite element simulation model of micro-milling thin-walled parts by setting the boundary condition module of the load of the finite element simulation model of micro-milling thin-walled parts, including spindle speed, feed rate per tooth, axial cutting depth and radial cutting depth; then checking the data and submitting the operation to predict the force of micro-milling thin-walled parts;
step 5: geometric models and meshing of the deformation prediction model of micro-milling thin-walled parts
according to the processing requirements, setting workpiece size of the deformation prediction model of micro-milling thin-walled parts; establishing geometrical model of the workpiece by using the finite element simulation software; the material properties are consistent with Johnson-Cook model in Step 2, and dividing the meshes of the workpiece; dividing the meshes according to the principle of accurate deformation data output by elements and nodes; selecting static implicit and three-dimensional stresses for mesh element types;
step 6: element coding and load of the deformation prediction model of micro-milling thin-walled parts
to realize the dynamic loading of deformation prediction model of micro-milling thin-walled parts and complete the element deletion to simulate the milling process, corresponding analysis steps need to be set, and each analysis step contains the element and node at the corresponding position; renumbering the processing area in order from top to bottom and right to left by the method of element recoding; using INP files to select the elements and nodes of the deformation prediction model of micro-milling thin-walled parts and set up the SET set; then, recoding the elements that need to be encoded in the processing area from 1, and inputting each column of the SET into the INP file to process and remove part of the elements and their nodes to complete the coding and integration of the elements; the node recoding method is consistent with the element recoding method;
according to step 4, using the finite element simulation model of micro-milling thin-walled parts to obtain the micro-milling force value under different cutting parameters; in the deformation prediction model of micro-milling thin-walled parts, dynamically applying the micro-milling forces predicted by the finite element simulation model of micro-milling thin-walled parts to the SET set to complete the loading process;
step 7: element deletion of the deformation prediction model of micro-milling thin-walled parts
in the establishment of the element deletion model of the deformation prediction model of micro-milling thin-walled parts, setting the micro-milling force loading of each SET, and deleting the element when reaching the failure condition e⁻⁸;
step 8: deformation prediction of micro-milling thin-walled parts
according to steps 5-7, completing the deformation prediction model of micro-milling thin-walled parts; applying dynamic micro-milling force and taking the node as the output point of the deformation of thin-walled part, which realizing the deformation prediction model of micro-milling thin-walled parts.
